(19) United States
(12) Patent Application Publication
(10) Pub. No.: US 2020/0103662 A1
(43) Pub. Date: Apr. 2, 2020

(54) HEAD-MOUNTED DISPLAY APPARATUS

(71) Applicant: SEIKO EPSON CORPORATION, Tokyo (JP)

(72) Inventor: Kazuya KAMAKURA, Matsumoto-shi (JP)

(73) Assignee: SEIKO EPSON CORPORATION, Tokyo (JP)

(21) Appl. No.: 16/583,424

(22) Filed: Sep. 26, 2019

(30) Foreign Application Priority Data
Sep. 27, 2018 (JP) 2018-182318

(51) Int. Cl. G02B 27/01; G02C 5/00

(52) U.S. Cl. CPC G02B 27/0176; G02B 27/0179; G02B 2027/0187; G02B 27/0172; G02B 2027/0178; G02C 5/001

(57) ABSTRACT

A head-mounted display apparatus includes a support portion, and first and second temples, the support portion includes first and second shaft support portions pivotably supporting the respective first and second temples, the first temple includes a first extension portion and a first modern, the second temple includes a second extending portion and a second modern, in which a tip portion of the first modern is positioned with respect to the first extension portion in a bent state of the first temple is a third direction, and when the bent state of the first and second temples is viewed from the second direction, the first extension portion extends to incline in a direction opposite to the third direction while proceeding toward the first direction, and the second extension portion extends to incline in a direction opposite to the third direction while proceeding toward a direction opposite to the first direction.

The present application is based on, and claims priority from JP Application Serial Number 2018-182318, filed Sep. 27, 2018, the disclosure of which is hereby incorporated by reference herein in its entirety.

### BACKGROUND

### 1. Technical Field

The present disclosure relates to a head-mounted display apparatus.

### 2. Related Art

In the past, a head-mounted display apparatus that is used by being mounted on the head of a user and displays an image such that the image is visually recognizable by the user has been known. As such a head-mounted display apparatus, a head mounted display (HMD) including an eyeglass type frame has been known (see, for example, JP-A-2012-54713).

The HMD in JP-A-2012-54713 includes a control unit, a projection unit, and a frame. The frame is a portion that supports the projection unit and is mounted to the head of a user, and has a front portion positioned in front of the face of the user, armor portions extending backward from both left and right end portions of the front portion respectively, and a pair of temple portions pivotally coupled to the respective armor portions. The pair of temple portions is a site that sandwiches the face of the user from both left and right sides, once bulges outward from a front side to a rear side, and then goes inward to be along the head of the user, that is, has a curving shape as a whole. Each of the temple portions has a cell portion that is a portion hanging on the ear of the user in a latter half portion advancing inward while proceeding from the front side to the rear side. The cell portion is formed to curve to advance obliquely downward while proceeding from the front side to the rear side.

The temple portion and the armor portion described above are coupled by a hinge portion provided at a rear end portion of the armor portion. Specifically, the temple portion is pivotally coupled at the hinge portion with a vertical direction being a pivot shaft direction so that the temple portion can be folded with respect to a configuration including the front portion and the armor portion. Accordingly, an aspect of the pair of temple portions is supported to be openable and closable with respect to the front portion, and is along the head of the user in an open state.

As described above, the temple portion in the HMD described in JP-A-2012-54713 is pivotally coupled to the armor portion with the vertical direction being the pivot shaft direction, and the cell portion is provided in the latter half portion of the temple portion. Thus, when the temple portion is folded with respect to the configuration including the front portion and the armor portion, depending on a size of the cell portion, the cell portion protrudes downward a transmissive sheet member provided as an aspect such as lenses of common eyeglasses and covering the left and right eyes of the user. In this case, there is a problem that it is difficult to accommodate the HMD in a case, a bag, and the like.

### SUMMARY

A head-mounted display apparatus according to a first aspect of the present disclosure includes a display unit configured to emit image light to display an image formed by the image light, a support portion configured to support the display unit, and a first temple and a second temple each pivotally provided on the support portion, wherein the support portion includes a first shaft support portion pivotally supporting the first temple about a first pivot shaft and a second shaft support portion pivotally supporting the second temple about a second pivot shaft, the first temple includes a first extension portion coupled with the first shaft support portion and a first modern provided on a side of the first extension portion opposite to the first shaft support portion, the second temple includes a second extension portion coupled with the second shaft support portion and a second modern provided on a side of the second extension portion opposite to the second shaft support portion, and provided that a direction from the first shaft support portion toward the second shaft support portion is a first direction, an extension direction, intersecting with the first direction, of the first extension portion from the first shaft support portion in a state in which the first temple is stretched is a second direction, and a direction, intersecting with the first direction and the second direction, in which a tip portion of the first modern is positioned with respect to the first extension portion in a state in which the first temple is bent at the first shaft support portion to be along the first direction is a third direction, and when a state in which the first temple is bent at the first shaft support portion is viewed from the second direction and the second temple is bent at the second shaft support portion, the first extension portion extends from the first shaft support portion to incline in a direction opposite to the third direction while proceeding in the first direction and the second extension portion extends from the second shaft support portion to incline in a direction opposite to the third direction while proceeding in a direction opposite to the first direction.

In the first aspect, when viewed from the second direction, the first pivot shaft and the second pivot shaft may be inclined, while proceeding in the third direction, in a direction approaching a center line parallel to the third direction and passing through a center of the head-mounted display apparatus in the first direction.

In the above first aspect, the first pivot shaft and the second pivot shaft may be inclined in a direction opposite to the second direction while proceeding in the third direction.

A head-mounted display apparatus according to a second aspect of the present disclosure is a head-mounted display apparatus that includes a display unit configured to emit image light to display an image formed by the image light, a support portion configured to support the display unit, and a first temple and a second temple each pivotally provided on the support portion, wherein the support portion includes a first shaft support portion pivotally supporting the first temple about a first pivot shaft and a second shaft support portion pivotally supporting the second temple about a second pivot shaft, the first temple includes a first extension portion coupled with the first shaft support portion and a first modern provided on a side of the first extension portion opposite to the first shaft support portion, the second temple includes a second extension portion coupled with the second shaft support portion and a second modern provided on a side of the second extension portion opposite to the second shaft support portion, and provided that a direction from the first shaft support portion toward the second shaft support portion is a first direction, an extension direction, intersecting with the first direction, of the first extension portion from the first shaft support portion in a state in which the first temple is stretched is a second direction, and a direction, intersecting with the first direction and the second direction, in which a tip portion of the first modern is positioned with respect to the first extension portion in a state in which the first temple is bent at the first shaft support portion to be along the first direction is a third direction, when viewed from the second direction, the first pivot shaft and the second pivot shaft are inclined, while proceeding in the third direction, in a direction approaching a center line parallel to the third direction and passing through a center of the head-mounted display apparatus in the first direction.

A head-mounted display apparatus according to a third aspect of the present disclosure includes a display unit configured to emit image light to display an image formed by the image light, a support portion configured to support the display unit, and a first temple and a second temple each pivotally provided on the support portion, wherein the support portion includes a first shaft support portion pivotally supporting the first temple about a first pivot shaft and a second shaft support portion pivotally supporting the second temple about a second pivot shaft, the first temple includes a first extension portion coupled with the first shaft support portion and a first modern provided on a side of the first extension portion opposite to the first shaft support portion, the second temple includes a second extension portion coupled with the second shaft support portion and a second modern provided on a side of the second extension portion opposite to the second shaft support portion, and provided that a direction from the first shaft support portion toward the second shaft support portion is a first direction, an extension direction, intersecting with the first direction, of the first extension portion from the first shaft support portion in a state in which the first temple is stretched is a second direction, and a direction, intersecting with the first direction and the second direction, in which a tip portion of the first modern is positioned with respect to the first extension portion in a state in which the first temple is bent at the first shaft support portion to be along the first direction is a third direction, the first pivot shaft and the second pivot shaft are inclined in a direction opposite to the second direction while proceeding in the third direction.

In the above first to third aspects, the display unit includes an image emitting unit configured to emit the image light and a light-guiding portion configured to guide the image light emitted from the image emitting unit to a predetermined visual recognition position, and at least one temple of the first temple and the second temple may be positioned on a center side of the head-mounted display apparatus in the first direction with respect to the image emitting unit.

### BRIEF DESCRIPTION OF THE DRAWINGS

FIG. 1 is a front view illustrating a head-mounted display apparatus according to a first embodiment of the present disclosure.

FIG. 2 is a perspective view illustrating the head-mounted display apparatus according to the above first embodiment.

FIG. 3 is a perspective view illustrating the head-mounted display apparatus according to the above first embodiment.

FIG. 4 is a plan view illustrating the head-mounted display apparatus according to the above first embodiment.

FIG. 5 is a rear view illustrating the head-mounted display apparatus according to the above first embodiment.

FIG. 6 is an exploded perspective view illustrating an apparatus body according to the above first embodiment.

FIG. 7 is an exploded perspective view illustrating the apparatus body according to the above first embodiment.

FIG. 8 is a front view illustrating a left side housing and a right side housing according to the above first embodiment.

FIG. 9 is a perspective view illustrating a temple according to the above first embodiment.

FIG. 10 is a perspective view illustrating the temple according to the above first embodiment.

FIG. 11 is a side view illustrating the left side housing and the temple according to the above first embodiment.

FIG. 12 is a front view illustrating the left side housing and the temple according to the above first embodiment.

FIG. 13 is a plan view illustrating the head-mounted display apparatus according to the above first embodiment with one temple being in a bent state.

FIG. 14 is a rear view illustrating the head-mounted display apparatus according to the above first embodiment with the one temple being in the bent state.

FIG. 15 is a plan view illustrating a head-mounted display apparatus according to a second embodiment of the present disclosure.

FIG. 16 is a front view illustrating a left side housing and a temple according to the above second embodiment.

FIG. 17 is a side view illustrating the left side housing and the temple according to the above second embodiment.

FIG. 18 is a rear view illustrating the head-mounted display apparatus according to the above second embodiment with one temple being in the bent state.

FIG. 19 is a perspective view illustrating a head-mounted display apparatus that is a modification of the head-mounted display apparatuses according to the above first and second embodiments.

### DESCRIPTION OF EXEMPLARY EMBODIMENTS

### First Embodiment

Hereinafter, a first embodiment according to the present disclosure will be described based on the accompanying drawings.

Overall Configuration of Head-Mounted Display Apparatus

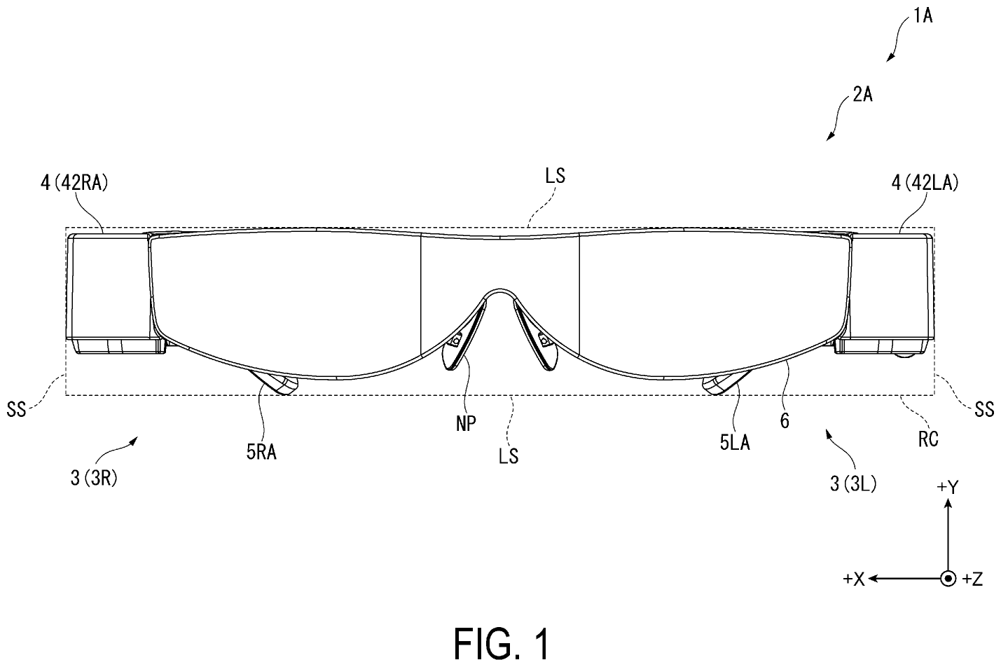

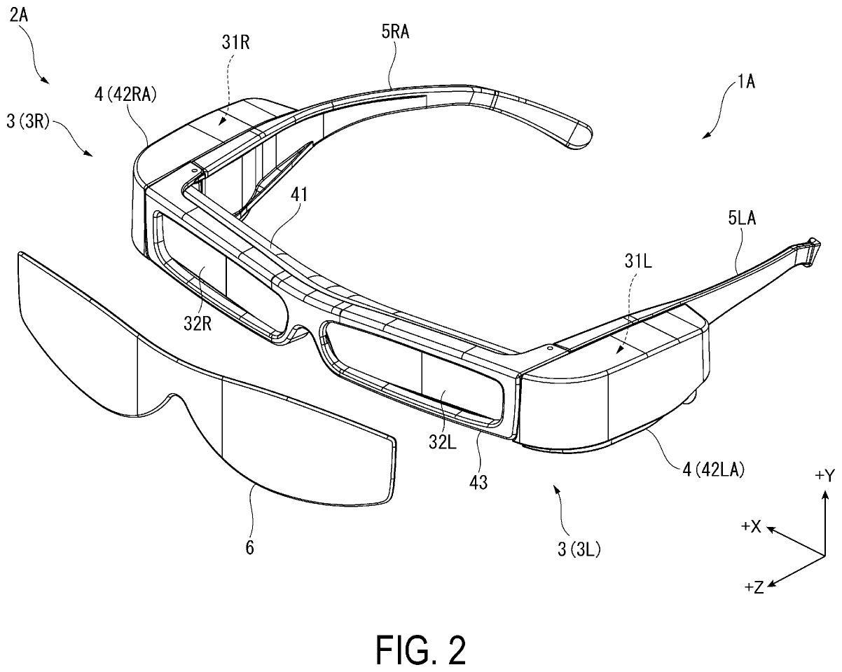

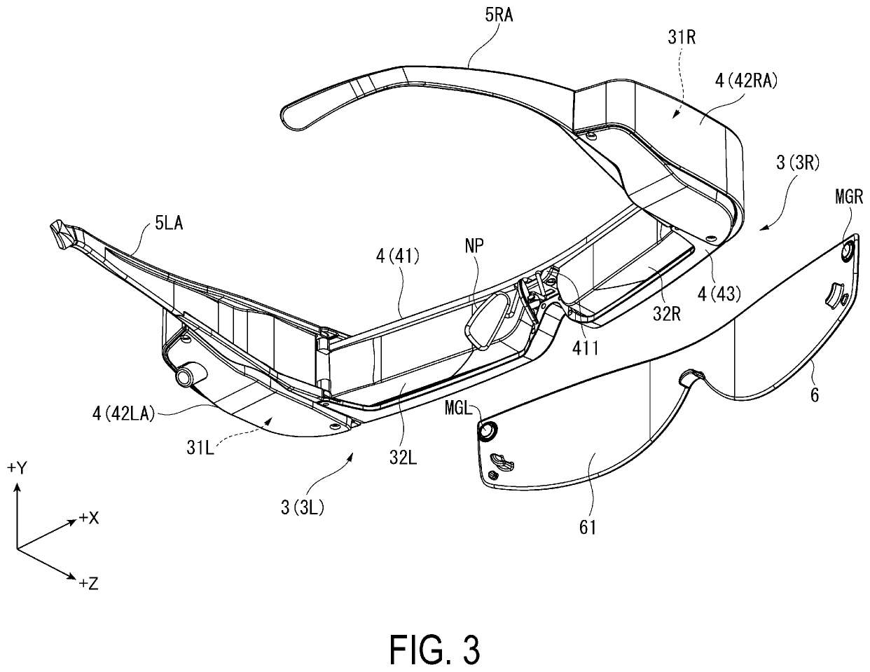

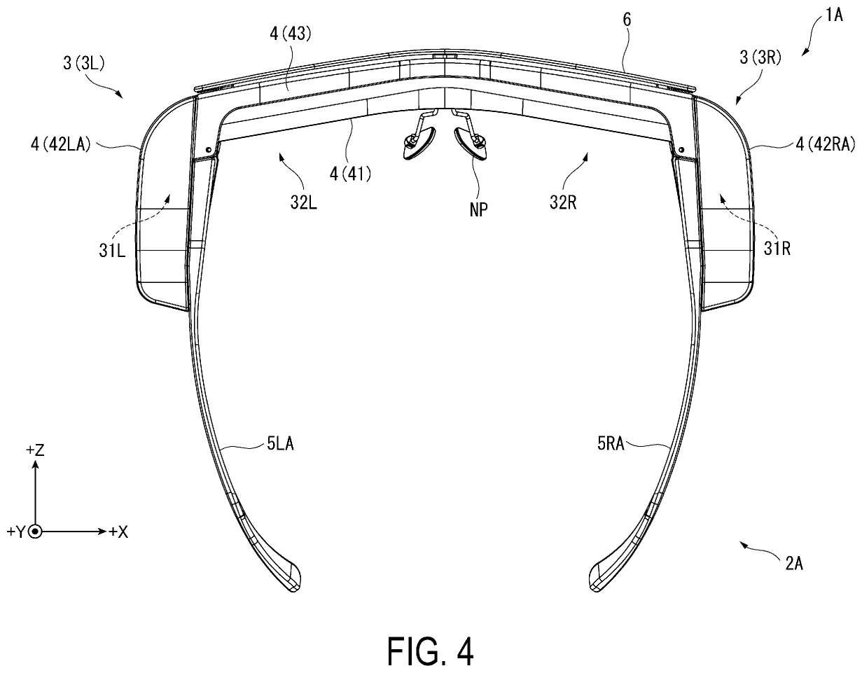

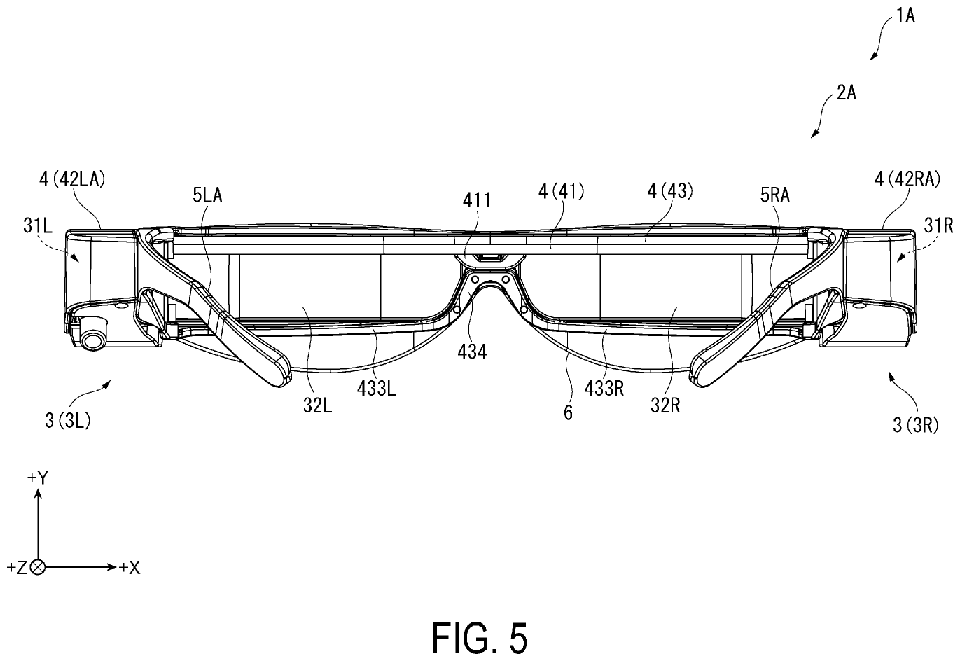

FIG. 1 is a front view illustrating a head-mounted display apparatus 1A according to the present embodiment. In detail, FIG. 1 is a front view illustrating the head-mounted display apparatus 1A in which a disposition state of temples 5LA and 5RA described later is a stretched state. Further, FIG. 2 and FIG. 3 are perspective views of the head-mounted display apparatus 1A viewed from an upper front side and a lower rear side, respectively. In detail, FIG. 2 and FIG. 3 are exploded perspective views illustrating the head-mounted display apparatus 1A with a cover member 6 separated from an apparatus body 2A. Additionally, FIG. 4 is a plan view of the head-mounted display apparatus 1A viewed from above, and FIG. 5 is a rear view illustrating the head-mounted display apparatus 1A.

The head-mounted display apparatus 1A according to the present embodiment is a virtual image display device that is used by being mounted on the head of a user to emit image light, and displays an image formed by the emitted image light for the user to be able to visually recognize, and is a so-called HMD. As illustrated in FIG. 1 to FIG. 5, the head-mounted display apparatus 1A includes the apparatus body 2A and the cover member 6 detachably provided on the apparatus body 2A.

In descriptions below, three directions that are perpendicular to each other are defined as a +X direction, a +Y direction, and a +Z direction respectively, and a direction from a rear side of the head-mounted display apparatus 1A toward a front side is defined as the +Z direction. Additionally, when the head-mounted display apparatus 1A is viewed from the +Z direction, a direction from right to left is defined as the +X direction, and when the head-mounted display apparatus 1A is viewed from the +Z direction, a direction from bottom to top is defined as the +Y direction.

In the present embodiment, a direction opposite to a direction in which a display unit 3 described later emits image light is defined as the +Z direction. In addition, as indicated by a dotted line in FIG. 1, when the head-mounted display apparatus 1A is viewed from the +Z direction, and a smallest rectangle RC is set that includes an outer shape of the head-mounted display apparatus 1A, a direction from right to left along a long side LS of the rectangle RC is defined as the +X direction, and a direction from bottom to top along a short side SS of the rectangle RC is defined as the +Y direction. Note that, the +X direction is parallel to a direction from a shaft support portion 42L2 described later of the apparatus body 2A toward a shaft support portion 42R2.

Also, although not illustrated, for convenience of explanation, an opposite direction to the +X direction is a −X direction, an opposite direction to the +Y direction is a −Y direction, and an opposite direction to the +Z direction is a −Z direction. That is, the +X direction corresponds to a first direction of the present disclosure, the −Z direction corresponds to a second direction of the present disclosure, and the −Y direction corresponds to a third direction of the present disclosure.

Note that, for the user wearing the head-mounted display apparatus 1A, the +X direction is a direction from left to right, the +Y direction is a direction from bottom to top, and the +Z direction is a direction from rear to front.

For this reason, in configurations of the head-mounted display apparatus 1A, reference numerals included in a left side for the user, that is, a configuration disposed in the −X direction are assigned “L”, and reference numerals included in a right side for the user, that is, a configuration disposed in the +X direction are assigned “R”.

Configuration of Cover Member

The cover member 6 is a member that is mounted on a mounted member 43 configuring a support portion 4 of the apparatus body 2A, and covers a left side light-guiding portion 32L and a right side light-guiding portion 32R configuring the display unit 3 of the apparatus body 2A in the +Z direction. The cover member 6 has a transmission suppressing property that suppresses transmission of light incident from the +Z direction. By mounting the cover member 6 on the apparatus body 2A, visibility of an image displayed by the display unit 3 is enhanced. Note that, the cover member 6 may have other properties such as wavelength selectivity for transmitting light in a predetermined wavelength band and shielding light in other wavelength bands, polarization selectivity for transmitting predetermined polarized light and shielding other polarized light, and the like.

As illustrated in FIG. 3, the cover member 6 includes a magnet MGL provided in the −X direction on a facing surface 61 that is a surface facing the mounted member 43, and a magnet MGR provided in the +X direction. Then, the cover member 6 is detachably mounted to the mounted member 43 by the magnets MGL and MGR being attracted to magnets 435L and 435R of the mounted member 43 respectively.

Configuration of Apparatus Body

The apparatus body 2A can be used as a head-mounted display apparatus alone. That is, the user is able to visually recognize an image by mounting the apparatus body 2A to the head, even in a state in which the cover member 6 is not used.

The apparatus body 2A includes the display unit 3, the support portion 4, and temples 5LA and 5RA.

Configuration of Display Unit

The display unit 3 emits image light at predetermined visual recognition positions, and displays images formed by the image light. Each of the predetermined visual recognition positions is a position of an exit pupil formed by an optical system configuring the display unit 3. In the present embodiment, the predetermined visual recognition positions are set to respective virtual positions that correspond to the left eye and the right eye of the user respectively, and the display unit 3 includes a left side display unit 3L emitting image light for the left eye to the left eye of the user that is one of the visual recognition positions to display an image for the left eye, and a right side display unit 3R emitting image light for the right eye to the right eye of the user that is another of the visual recognition positions to displays an image for the right eye.

Configuration of Left Side Display Unit

The left side display unit 3L is positioned in the −X direction of the apparatus body 2A. The left side display unit 3L includes a left side emitting unit 31L as an image emitting unit that forms and emits an image for the left eye, and a left side light-guiding portion 32L as a light-guiding portion that guides the emitted image for the left eye to the left eye of the user.

The left side emitting unit 31L is accommodated in a left side housing 42LA described later, and forms and emits image light for the left eye in accordance with image information inputted from an outside. The left side emitting unit 31L includes a control unit, an image forming unit, and an image projection unit, although not illustrated.

The control unit outputs an image signal in accordance with inputted image information to the image forming unit, and makes the image forming unit form image light for the left eye in accordance with the image information. The control unit is a circuit board on which circuit elements are mounted.

The image forming unit forms image light for the left eye in accordance with an image signal inputted from the control unit. The image forming unit can be constituted of a self-luminescent display panel such as an organic electro-luminescence (EL) panel, and can be constituted by combining a light source such as an LED, a liquid crystal panel, and a light modulation device such as a device using a micromirror such as an MEMS mirror, or the like.

The image projection unit is constituted of a lens and a prism, and projects image light formed by the image forming unit onto the left side light-guiding portion 32L.

The left side light-guiding portion 32L is supported by a frame 41 described later of the support portion 4, and is disposed at a position corresponding to the left eye of the user. The left side light-guiding portion 32L guides image light for the left eye emitted from the left side emitting unit 31L in the +X direction while internally reflecting at an interface, and emits to the left eye by a semi-transparent layer provided corresponding to the left eye of the user. In other words, the left side display unit 3L emits the image light for the left eye from the left side light-guiding portion 32L in the −Z direction that is the second direction. The left light-guiding portion 32L is formed of resin such as a cycloolefin polymer that exhibits high translucency in a visible light region, for example, and the user can observe an external scene via the left side light-guiding portion 32L.

Configuration of Right Side Display Unit

The right side display unit 3R is positioned in the +X direction of the apparatus body 2A. The right side display unit 3R includes a right side emitting unit 31R as an image emitting unit that forms and emits image light for the right eye, and a right side light-guiding portion 32R as a light-guiding portion that guides the emitted image light for the right eye to the right eye of the user.

The right side emitting unit 31R is accommodated in a right side housing 42RA described later, and forms and emits image for the right eye in accordance with image information inputted from an outside. Similar to the left side emitting unit 31L, the right side emitting unit 31R includes a control unit, an image forming unit, and an image projection unit.

The right side light-guiding portion 32R is supported by the frame 41, and is disposed at a position corresponding to the right eye of the user. The right side light-guiding portion 32R guides image light for the right eye emitted from the right side emitting unit 31R in the −X direction while internally reflecting at an interface, and emits to the right eye by a semi-transparent layer provided corresponding to the right eye of the user. In other words, the right side display unit 3R emits the image light for the right eye forming the image for the right eye from the right side light-guiding portion 32R in the −Z direction that is the second direction. The right side light-guiding portion 32R is constituted of a material having similar translucency to the left side light-guiding portion 32L, for example, and the user can observe the external scene via the right side light-guiding portion 32R.

As described above, the apparatus body 2A is a see-through type head-mounted display apparatus that allows the user to observe images and the external scene simultaneously.

Configuration of Support Portion

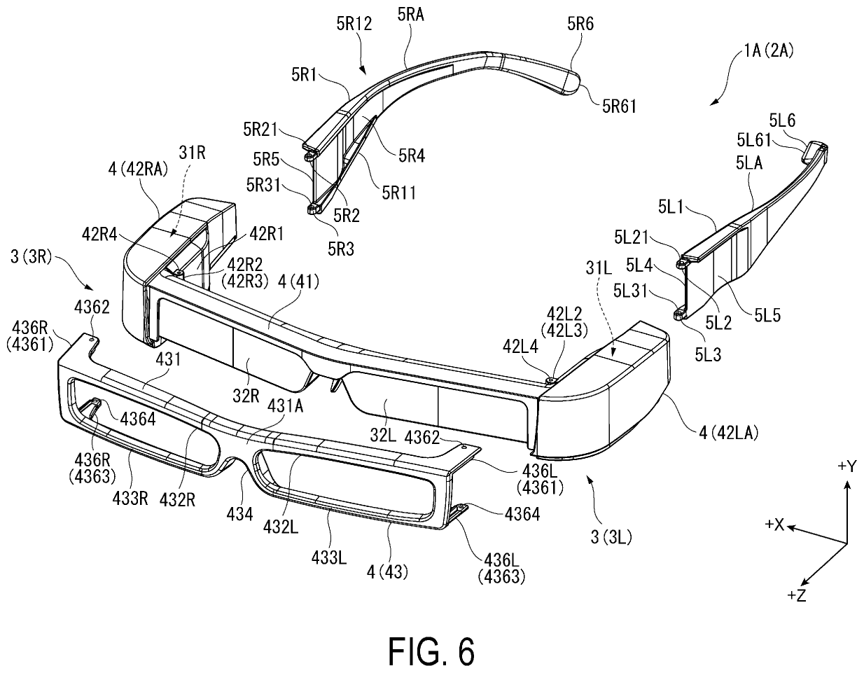

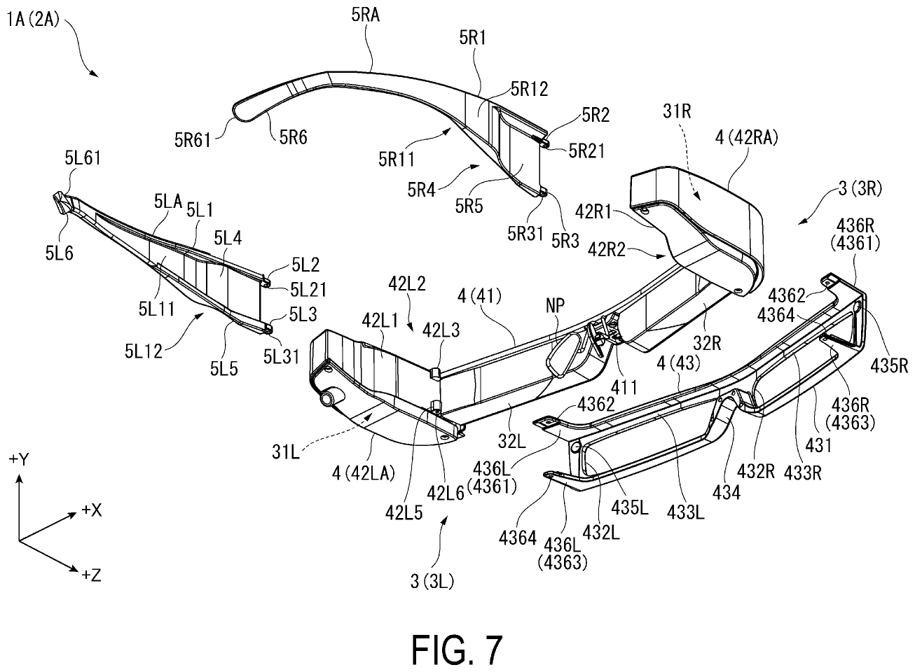

FIG. 6 and FIG. 7 are exploded perspective views illustrating the apparatus body 2A viewed from an upper front side and a lower rear side, respectively.

The support portion 4 supports the display unit 3, and pivotally supports the temples 5LA and 5RA. As illustrated in FIG. 6 and FIG. 7, the support portion 4 includes the frame 41 extending in the +X direction, the left side housing 42LA and the right side housing 42RA being each attached to the frame 41, and the mounted member 43.

Configuration of Frame

The frame 41 is a metal member substantially U-shaped when viewed from the +Y direction, in which one end is positioned in the −X direction and another end is positioned in the +X direction. The frame 41 is positioned in the +Y direction with respect to the left side light-guiding portion 32L and the right sight light-guiding portion 32R, and supports the left side light-guiding portion 32L and the right side light-guiding portion 32R.

As illustrated in FIG. 7, an attachment member 411 is attached to a center in the +X direction on a surface in the −Y direction of the frame 41. The attachment member 411 is attached to sandwich a portion of the left side light-guiding portion 32L and a portion of the right side light-guiding portion 32R, together with the surface in the −Y direction of the frame 41. A nose pad NP that comes into contact with the nose of the user is detachably attached to the attachment member 411. Note that, although not illustrated, the nose pad NP can be configured in accordance with a shape and a size of the nose of the user, and can be replaced for each user using the head-mounted display apparatus 1A.

Configuration of Mounted Member

Here, the mounted member 43 is described first.

The mounted member 43 is fixed to the left side housing 42LA and the right side housing 42RA, with the frame 41, the left side light-guiding portion 32L, and the right side light-guiding portion 32R covered in the +Z direction. The mounted member 43 is a site of the support portion 4 on which the cover member 6 is detachably mounted.

The mounted member 43 includes a main body 431 disposed in the +Z direction with respect to the left side light-guiding portion 32L and the right side light-guiding portion 32R, and fixing portions 436L and 436R each extending in the −Z direction from the main body 431.

The main body 431 includes a left side frame portion 433L that forms a left side opening portion 432L, a right side frame portion 433R that forms a right side opening portion 432R, and a movement regulating unit 434. In addition, the main body 431 includes the magnets 435L and 435R that attract the cover member 6, as illustrated in FIG. 7.

As illustrated in FIG. 6 and FIG. 7, the left side frame portion 433L is positioned in the +Z direction with respect to the left side light-guiding portion 32L, and surrounds a display region for the image for the left eye formed by the image light for the left eye emitted from the left side light-guiding portion 32L, when viewed from the +Z direction.

The right side frame portion 433R is positioned in the +Z direction with respect to the right side light-guiding portion 32R, and surrounds a display region for the image for the right eye formed by the image light for the right eye emitted from the right side light-guiding portion 32R, when viewed from the +Z direction.

When the user observes the external scene via the left side light-guiding portion 32L and the right side light-guiding portion 32R, line of sight of the user passes through the left side opening portion 432L and the right side opening portion 432R.

Note that, a region of the left side light-guiding portion 32L surrounded by the left side frame portion 433L viewed from the +Z direction, that is, the left side opening portion 432L viewed from the +Z direction, may include the display region for the image for the left eye, and additionally a region through which external light passes toward the left eye of the user. Further, a region of the right side light-guiding portion 32R surrounded by the right side frame portion 433R viewed from the +Z direction, that is, the right side opening portion 432R viewed from the +Z direction, may include the display region for the image for the right eye, and additionally a region through which external light passes toward the right eye of the user.

In such a case, while visually recognizing at least one image of the image for the left eye and the image for the right eye, the user can observe the external scene outside the display region for the images.

The movement regulating unit 434 is provided at a center in the +X direction at an end edge in the −Y direction of the main body 431. In other words, the movement regulating unit 434 is provided at a position on which the left side frame portion 433L and the right side frame portion 433R overlap. The movement regulating unit 434 is disposed to be able to contact the attachment member 411, regulates movement of the mounted member 43, is in contact with a portion of the cover member 6, and restricts movement of the cover member 6 in the +Y direction.

As illustrated in FIG. 7, the magnet 435L is provided at a corner portion in the −X direction and in the +Y direction of a surface in the −Z direction of the main body 431. The magnet 435R is provided at a corner portion in the +X direction and in the +Y direction of the surface in the −Z direction of the main body 431. The magnets 435L and 435R absorb the respective magnets MGL and MGR to attract the cover member 6. As a result, the cover member 6 is detachably mounted to the mounted member 43 to cover a front face 431A in the +Z direction.

As illustrated in FIG. 6 and FIG. 7, the fixing portion 436L is provided at a position near an end portion in the −X direction of the main body 431. The fixing portion 436L includes an upper side arm portion 4361 extending in the −Z direction from an end edge in the +Y direction of the main body 431, and a lower side arm portion 4363 extending in the −Z direction from an end edge in the −Y direction of the main body 431. The upper side arm portion 4361 includes a through-hole 4362 that penetrates in the −Y direction, and the lower side arm portion 4363 includes a through-hole 4364 that penetrates in the +Y direction.

The fixing portion 436R is provided at a position near an end portion in the +X direction of the main body 431. Similar to the fixing portion 436L, the fixing portion 436R includes the upper side arm portion 4361 having the through-hole 4362, and the lower side arm portion 4363 having the through-hole 4364.

Additionally, the upper side arm portion 4361 and the lower side arm portion 4363 of the fixing portion 436L are fixed to the shaft support portion 42L2 of the left side housing 42LA, and the upper side arm portion 4361 and the lower side arm portion 4363 of the fixing portion 436R are fixed to the shaft support portion 42R2 of the right side housing 42RA, to fix the mounted member 43 as described above.

Configuration of Left Side Housing

The left side housing 42LA is a housing made of a synthetic resin and is attached to an end portion in the −X direction of the frame 41 to accommodate the left side emitting unit 31L. The left side housing 42LA includes the shaft support portion 42L2 on a side surface 42L1 in the +X direction that is a side of the right side housing 42RA.

The shaft support portion 42L2 is provided on an end portion in the +Z direction of the side surface 42L1, pivotally supports the temple 5LA, and is a site to which the fixing portion 436L is fixed. The shaft support portion 42L2 includes an attachment portion 42L3 positioned in the +Y direction, and an attachment portion 42L5 positioned in the −Y direction. The attachment portion 42L3 includes a screw hole 42L4 screwed with an unillustrated screw that is inserted into the through-hole 4362 of the fixing portion 436L and a through-hole 5L21 described later of the temple 5LA, along the −Y direction.

The attachment portion 42L5 includes an unillustrated screw hole screwed with an unillustrated screw that is inserted into the through-hole 4364 of the fixing portion 436L and a through-hole 5L31 described later of the temple 5LA, along the +Y direction.

Configuration of Right Side Housing

The right side housing 42RA is a housing made of a synthetic resin and is attached to an end portion on a side in the +X direction of the frame 41 to accommodate the right side emitting unit 31R. The right side housing 42RA includes the shaft support portion 42R2 on a side surface 42R1 in the −X direction that is a side of the left side housing 42LA.

The shaft support portion 42R2 is provided on an end portion in the +Z direction of the side surface 42R1, pivotally supports the temple 5RA, and is a site to which the fixing portion 436R is fixed. The shaft support portion 42R2, similar to the shaft support portion 42L2, includes an attachment portion 42R3 positioned in the +Y direction, and an attachment portion 42R5 positioned in the −Y direction.

The attachment portion 42R3 includes a screw hole 42R4 screwed with an unillustrated screw that is inserted into the through-hole 4362 of the fixing portion 436R and a through-hole 5R21 described later of the temple 5RA, along the −Y direction.

The attachment portion 42R5 includes an unillustrated screw hole screwed with an unillustrated screw that is inserted into the through-hole 4364 of the fixing portion 436R and a through-hole 5R31 described later of the temple 5RA, along the +Y direction.

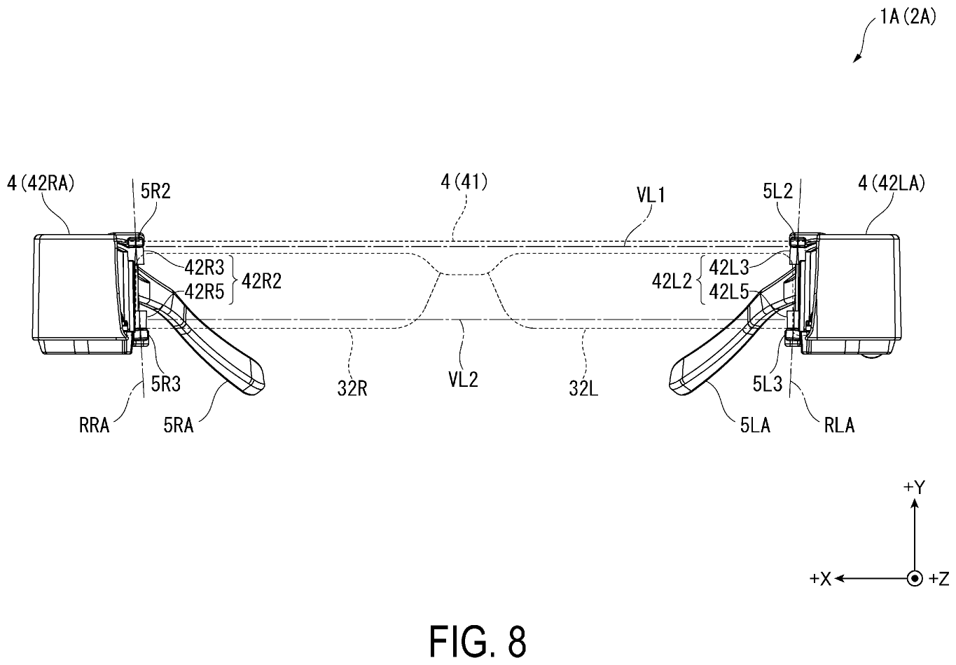

FIG. 8 is a front view illustrating the left side housing 42LA and the right side housing 42RA. Note that, in FIG. 8, in order to illustrate respective positions of the frame 41, the left side light-guiding portion 32LA, and the right side light-guiding portion 32RA, these are illustrated by dotted lines.

As illustrated in FIG. 8, a direction connecting the shaft support portion 42L2 and the shaft support portion 42R2 is parallel to an axis parallel to the +X direction. That is, when the shaft support portion 42L2 is a first shaft support portion and the shaft support portion 42R2 is a second shaft support portion, a direction from the shaft support portion 42L2 toward the shaft support portion 42R2 is parallel to the −X direction.

In detail, a direction from the attachment portion 42L3 of the shaft support portion 42L2 toward the attachment portion 42R3 of the shaft support portion 42R2 is parallel to the +X direction, and a direction from the attachment portion 42L5 of the shaft support portion 42L2 toward the attachment portion 42R5 of the shaft support portion 42R2 is parallel to the +X direction. In other words, an imaginary line VL1 connecting the attachment portions 42L3 and 42R3 is parallel to the +X direction, and an imaginary line VL2 connecting the attachment portions 42L5 and 42R5 is parallel to the +X direction.

Note that, as will be described in detail later, the pivot shaft RLA of the temple 5LA supported by the shaft support portion 42L2, and the pivot shaft RRA of the temple 5RA supported by the shaft support portion 42R2 each are not completely parallel to the +Y direction, and are not parallel with each other. The pivot shafts RLA and RRA will be described in detail later.

Configuration of Temple

As illustrated in FIG. 6 to FIG. 8, the temple 5LA is pivotally supported by the shaft support portion 42L2, and the temple 5RA is pivotally supported by the shaft support portion 42R2. The temples 5LA and 5RA are stretched to be along the −Z direction when the apparatus body 2A is worn by the user, and are suspended on the left and right ears of the user, respectively.

Note that, a state in which the temples 5LA and 5RA are stretched such that respective extension directions from the shaft support portions 42L2 and 42R2 are along the −Z direction is defined as a stretched state. In addition, a state in which the temple 5LA is bent at the shaft support portion 42L2 such that the extension direction from the shaft support portion 42L2 is along the +X direction, and the temple 5RA is bent at the shaft support portion 42R2 such that the extension direction from the shaft support portion 42R2 is along the −X direction is defined as a bent state.

In descriptions below, a direction of the temple 5LA is a direction when the temple 5LA is in the stretched state, and a direction of the 5RA is a direction when the temple 5RA is in the stretched state.

Configuration of Left Side Temple

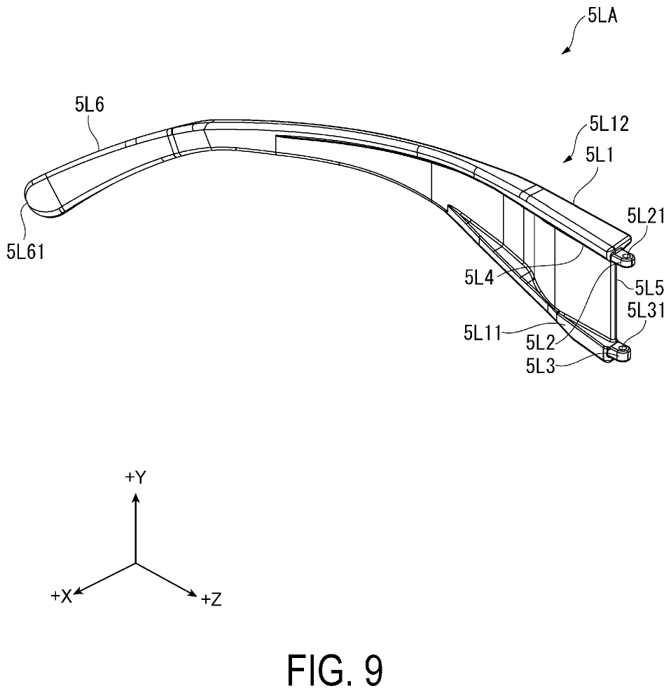

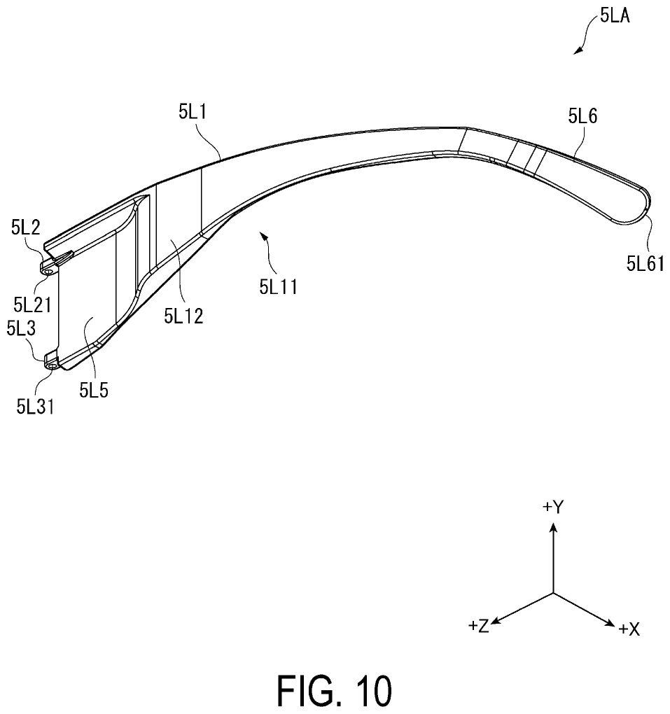

FIG. 9 is a perspective view of the temple 5LA extending in the −Z direction viewed from the +X direction and the +Y direction, and FIG. 10 is a perspective view of the temple 5LA extending in the −Z direction viewed from the −X direction and the −Y direction.

The temple 5LA is positioned in the +X direction with respect to the left side emitting unit 31L provided in the left side housing 42LA. In other words, the temple 5LA is positioned on a center side of the head-mounted display apparatus 1A in the +X direction with respect to the left side emitting unit 31L. The temple 5LA is pivotable in a pivotal range between the above stretched state and the above bent state.

The temple 5LA includes an extension portion 5L1 and a modern 5L6, and is formed as a shape in accordance with a left temporal region of the user, as illustrated in FIG. 9 and FIG. 10.

The extension portion 5L1 is a site of the temple 5LA from a support position by the shaft support portion 42L2 to a position corresponding to the left ear of the user. The extension portion 5L1 is formed as an arc that curves in the −X direction while proceeding from an end portion in the +Z direction toward the −Z direction, and subsequently curves in the +X direction while proceeding in the −Z direction.

The extension portion 5L1 includes coupling portions 5L2, 5L3, a disposition portion 5L4, and a recessed portion 5L5.

Each of the coupling portions 5L2 and 5L3 is provided to protrude in the +Z direction as a flake from an end portion in the +Z direction of the extension portion 5L1, and is a support position by the shaft support portion 42L2. The coupling portion 5L2 is positioned in the +Y direction, and the coupling portion 5L3 is positioned in the −Y direction.

The coupling portion 5L2 is disposed between the attachment portion 42L3 and the upper side arm portion 4361 of the fixing portion 436L. The coupling portion 5L2 includes the through-hole 5L21 inserted with an unillustrated screw that is inserted into the through-hole 4362 of the upper side arm portion 4361, and the screw inserted into the through-hole 5L21 is screwed into the screw hole 42L4.

The coupling portion 5L3 is disposed between the attachment portion 42L5 and the lower side arm portion 4363 of the fixing portion 436L. The coupling portion 5L3 includes the through-hole 5L31 inserted with an unillustrated screw that is inserted into the through-hole 4364 of the lower side arm portion 4363, and the screw inserted into the through-hole 5L31 is screwed into the screw hole 42L6.

Thus, the temple 5LA is pivotally supported by the shaft support portion 42L2.

The disposition portion 5L4 is positioned on a side surface 5L11 in the +X direction of the extension portion 5L1, and is a recessed portion recessed in the −X direction. The disposition portion 5L4 is, when the head-mounted display apparatus 1A is mounted on the head of the user wearing eyeglasses, a site on which a temple of the eyeglasses is disposed.

The recessed portion 5L5 is provided on a side surface 5L12 in the −X direction of the extension portion 5L1, and is a recessed portion recessed in the +X direction. The recessed portion 5L5 is a site on which a portion of the left side housing 42LA is disposed when the temple 5LA is in the stretched state. In other words, the recessed portion 5L5 is a site that avoids a portion of the left side housing 42LA.

The modern 5L6 is a site that is disposed along a site behind the left ear of the user to suppress displacement of the head-mounted display apparatus 1A from the head. The modern 5L6 is formed on a side of the extension portion 5L1 opposite to the shaft support portion 42L2, that is, on a site opposite to the coupling portions 5L2 and 5L3 to be continuous with the extension portion 5L1. The modern 5L6 curves and extends in the +X direction and the −Y direction while proceeding toward the −Z direction. In other words, a tip portion 5L61 of the modern 5L6 is positioned in the −Y direction that is the third direction with respect to an end edge in the +Y direction of the extension portion 5L1.

Configuration of Right Side Temple

As illustrated in FIG. 6 and FIG. 7, the temple 5RA is positioned in the −X direction with respect to the right side emitting unit 31R provided in the right side housing 42RA. In other words, the temple 5RA is positioned on a center side of the head-mounted display apparatus 1A in the −X direction with respect to the right side emitting unit 31R. The temple 5RA is pivotable about the shaft support portion 42L2 in a pivotal range between the stretched state and the bent state.

The temple 5RA has a mirror symmetric structure with respect to the temple 5LA. Specifically, the temple 5RA includes the extension portion 5R1 and the modern 5R6, and is formed in a shape in accordance with a right temporal region of the user.

The extension portion 5R1 is a site of the temple 5RA from a support position by the shaft support portion 42R2 to a position corresponding to the right ear of the user. The extension portion 5R1 is formed as an arc that curves in the +X direction while proceeding from an end portion in the +Z direction toward the −Z direction, and subsequently curves in the −X direction while proceeding in the −Z direction. The extension portion 5R1 includes coupling portions 5R2, 5R3, a disposition portion 5R4, and a recessed portion 5R5 similar to the coupling portions 5L2, 5L3, the disposition portion 5L4, and the recessed portion 5L5. In addition, the coupling portion 5R2 includes the through-hole 5R21, and the coupling portion 5R3 includes the through-hole 5R31. Further, the coupling portions 5R2 and 5R3 are provided at an end portion in the +Z direction of the extension portion 5R1, the disposition portion 5R4 is provided on a side surface 5R11 in the −X direction of the extension portion 5R1, and the recessed portion 5R5 is provided on a side surface 5R12 in the +X direction of the extension portion 5R1.

The modern 5R6 is a site disposed along a site behind the right ear of the user, and sandwiches the head together with the modern 5L6, to suppress displacement of the head-mounted display apparatus 1A from the head. The modern 5R6 is formed on a side of the extension portion 5R1 opposite to the shaft support portion 42R2, that is, on a site opposite to the coupling portions 5R2 and 5R3 to be continuous with the extension portion 5R1, and curves and extends in the −X direction and the −Y direction while proceeding toward the −Z direction. In other words, a tip portion 5R61 of the modern 5R6 is positioned in the −Y direction that is the third direction with respect to an end edge in the +Y direction of the extension portion 5R1.

Inclination of Pivot Shaft of Temple

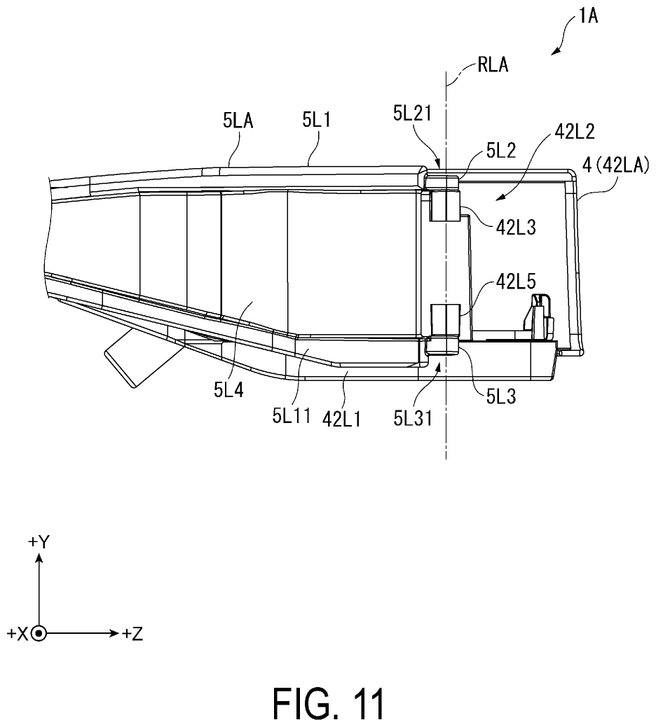

FIG. 11 is a side view of the left side housing 42LA and the temple 5LA in the stretched state viewed from the +X direction.

Here, the pivot shaft RLA of the temple 5LA will be described.

When the temple 5LA supported by the shaft support portion 42L2 is viewed from the +X direction, the pivot shaft RLA of the temple 5LA is parallel to the +Y direction, as illustrated in FIG. 11.

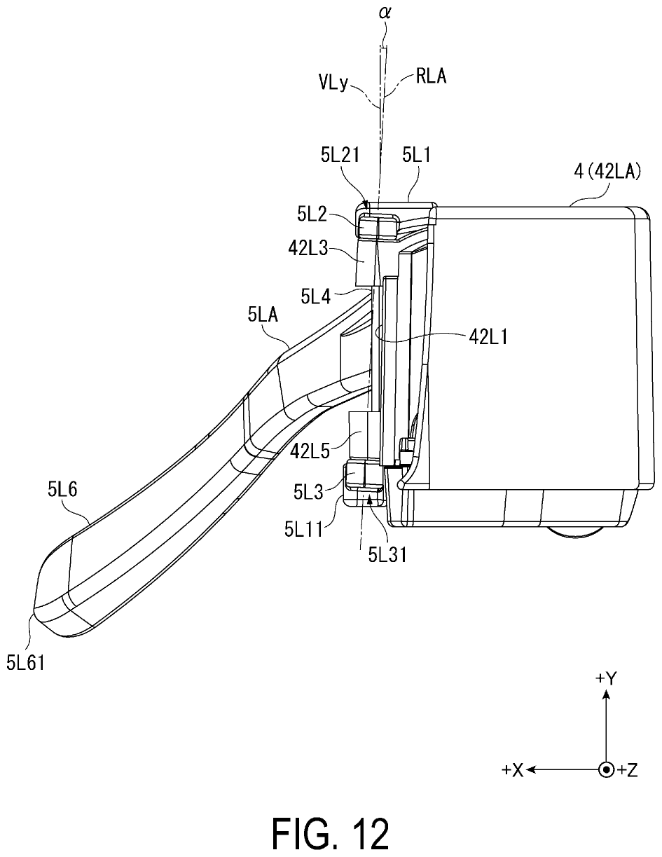

FIG. 12 is a front view of the left side housing 42LA and the temple 5LA in the stretched state viewed from the +Z direction.

On the other hand, when the temple 5LA is viewed from the +Z direction, the pivot shaft RLA is inclined with respect to the +Y direction, as illustrated in FIG. 12. A case where the temple 5LA is viewed from the −Z direction is similar to the above. In detail, when viewed from the +Z direction or the −Z direction, the pivot shaft RLA is inclined in the −X direction while proceeding toward the +Y direction, and is inclined in the +X direction that is the first direction while proceeding toward the −Y direction that is the third direction.

In the present embodiment, when viewed from the +Z direction or the −Z direction, a crossing angle α between the pivot shaft RLA and an imaginary line VLy parallel to the +Y direction is approximately 3°.

Also, although not illustrated, when the temple 5RA supported by the shaft support portion 42R2 is viewed from the −X direction, the pivot shaft RRA of the temple 5RA is parallel to the +Y direction.

On the other hand, when viewed from the +Z direction, the pivot shaft RRA is inclined in the +X direction while proceeding toward the +Y direction, and is inclined in the −X direction that is a direction opposite to the first direction, while proceeding toward the −Y direction that is the third direction.

Note that, the pivot shaft RRA is also inclined by approximately 3° with respect to the imaginary line VLy, when viewed from the +Z direction or the −Z direction.

Temple Position in Bent State

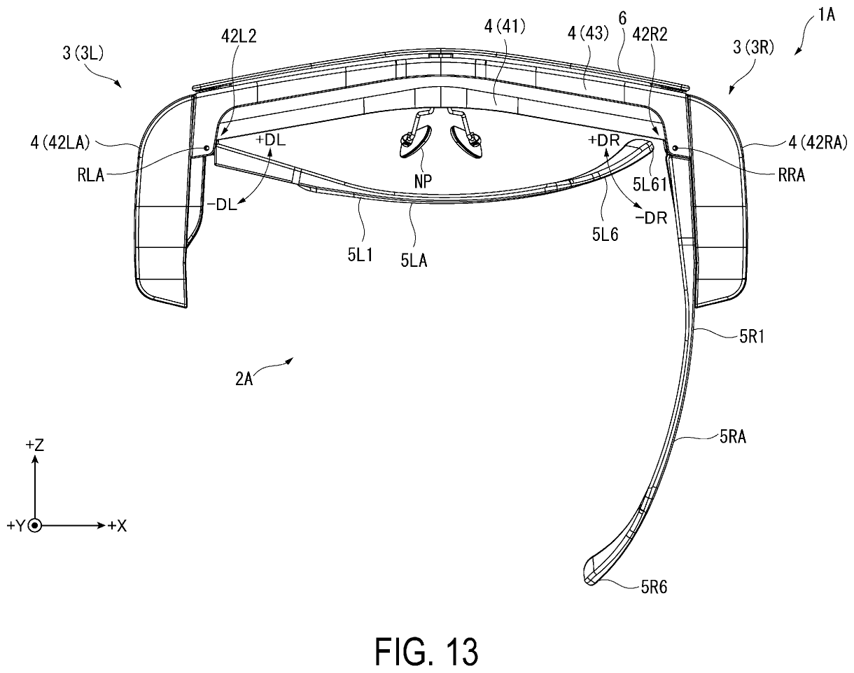

FIG. 13 is a plan view of the head-mounted display apparatus 1A with the temple 5LA set in the bent state viewed from the +Y direction.

The temple 5LA is pivotable about the pivot shaft RLA in a +DL direction in which the modern 5L6 approaches the temple 5RA, and in a −DL direction in which the modern 5L6 separates from the temple 5RA, as illustrated in FIG. 13. In other words, the temple 5LA is pivotable about the pivot shaft RLA in the +DL direction in which the modern 5L6 approaches the right side light-guiding portion 32R, and in the −DL direction in which the modern 5L6 separates from the right side light-guiding portion 32R.

Similarly, the temple 5RA is pivotable about the pivot shaft RRA in a +DR direction in which the modern 5R6 approaches the temple 5LA, and in a −DR direction in which the modern 5R6 separates from the temple 5LA. In other words, the temple 5RA is pivotable about the pivot shaft RRA in the +DR direction in which the modern 5R6 approaches the left side light-guiding portion 32L, and in the −DR direction in which the modern 5R6 separates from the left side light-guiding portion 32L.

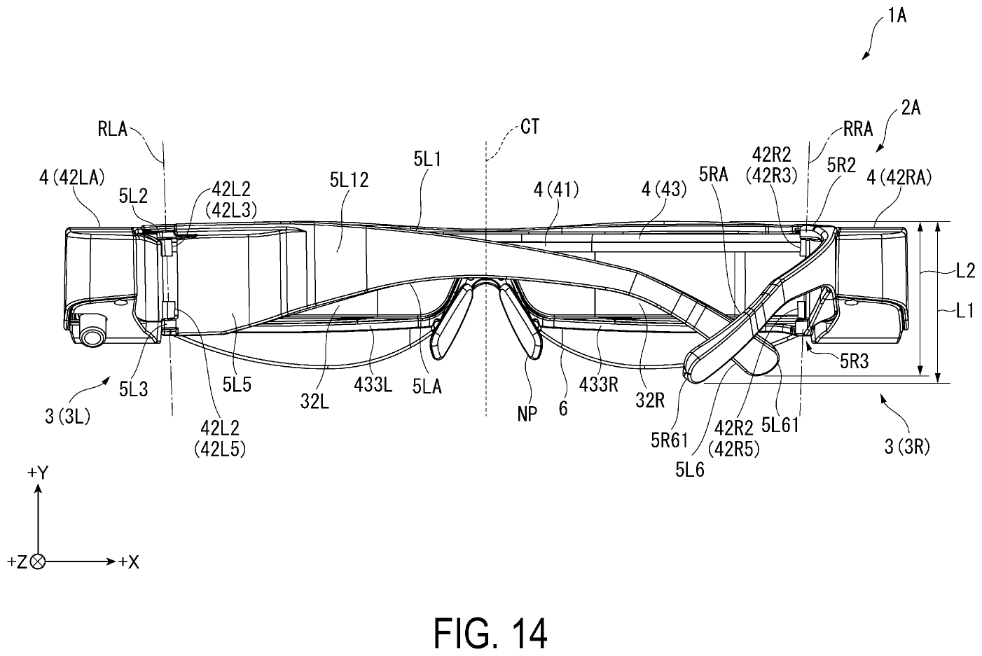

FIG. 14 is a rear view of the head-mounted display apparatus 1A viewed from the −Z direction. Note that, in FIG. 14, the temple 5LA is set in the bent state and the temple 5RA is set in the stretched state, in order to facilitate comparison between a case in which a disposition state of the temples 5LA and 5RA is the stretched state and a case of the bent state.

A dimension in the +Y direction of the head-mounted display apparatus 1A in the disposition state of the temples 5LA and 5RA when the head-mounted display apparatus 1A is mounted on the head, that is, when the temples 5LA and 5RA are in the stretched state, is a dimension L1 as illustrated in FIG. 14.

Here, in a head-mounted display apparatus of a first comparative example that has a similar configuration to that of the head-mounted display apparatus 1A, but in which a pivot shaft of a temple is parallel to the +Y direction viewed from the +/−X direction and +/−Z direction, a position in the +Y direction of a modern is identical regardless of whether the temple is in the stretched state or in the bent state. Thus, the dimension L1 is identical to a dimension in the +Y direction of the head-mounted display apparatus of the first comparative example, when the head-mounted display apparatus of the first comparative example is viewed from the −Z direction and left and right temples are in the bent state.

Compared to this, as illustrated in FIG. 14, when viewed from the −Z direction, the pivot shaft RLA is inclined in the +X direction that is the first direction while proceeding toward the −Y direction that is the third direction, and the pivot shaft RRA is inclined in the −X direction that is the direction opposite to the first direction while proceeding toward the −Y direction that is the third direction, respectively. That is, when viewed from the −Z direction, the pivot shaft RLA is inclined in a direction approaching the temple 5RA and the shaft support portion 42R2 while proceeding toward the −Y direction, and the pivot shaft RRA is inclined in a direction approaching the temple 5LA and the shaft support portion 42L2 while proceeding toward the −Y direction respectively. In other words, when viewed from the −Z direction, the pivot shafts RLA and RRA each are inclined in a direction approaching a center line CT parallel to the +Y direction and passing through a center of the head-mounted display apparatus 1A in the +X direction while proceeding toward the −Y direction. In other words, when viewed from the −Z direction, the pivot shafts RLA and RRA are inclined in respective directions that approach each other while proceeding toward the −Y direction.

Thus, when the temple 5LA is pivoted in the +DL direction and the temple 5LA is set in the bent state, the extension portion 5L1 extending in the +X direction extends from the shaft support portion 42L2 to incline in the +Y direction that is a direction opposite to the −Y direction that is a direction in which the tip portion 5L61 of the modern 5L6 is positioned with respect to the extension portion 5L1, while proceeding toward the +X direction. Also, although not illustrated, when the temple 5RA is pivoted in the +DR direction and is set in the bent state, the extension portion 5R1 extending in the −X direction extends from the shaft support portion 42R2 to incline in the +Y direction that is the direction opposite to the −Y direction that is a direction in which the tip portion 5R61 of the modern 5R6 is positioned with respect to the extension portion 5R1, while proceeding toward the −X direction.

Thus, when the head-mounted display apparatus 1A is viewed from the −Z direction that is the second direction with the respective temples 5LA and 5RA being in the bent state, a dimension in the +Y direction of the head-mounted display apparatus 1A is a dimension L2 smaller than the dimension L1.

In this way, the dimension L2 in the +Y direction of the head-mounted display apparatus 1A with the temples 5LA and 5RA being in the bent state is smaller than the above dimension L1, thus the head-mounted display apparatus 1A can be more easily accommodated.

### Effects of First Embodiment

According to the head-mounted display apparatus 1A according to the above-described present embodiment, advantages below can be obtained.

The head-mounted display apparatus 1A that is mounted on the head of the user to display an image for the user to be able to visually recognize includes the display unit 3 that emits image light and displays an image formed by the image light, the support portion 4 that supports the display unit 3, and the temples 5LA and 5RA that correspond to a first temple and a second temple respectively and are pivotally provided on the left side housing 42LA of the support portion 4. The left side housing 42LA of the support portion 4 includes the shaft support portion 42L2 that pivotally supports the temple 5LA about the pivot shaft RLA, and the right side housing 42RA of the support portion 4 includes the shaft support portion 42R2 that pivotally supports the temple 5RA about the pivot shaft RRA. Note that, the pivot shafts RLA and RRA correspond to a first pivot shaft and a second pivot shaft respectively, and the shaft support portions 42L2 and 42R2 correspond to the first shaft support portion and the second shaft support portion respectively.

The temple 5LA includes the extension portion 5L1 coupled at the coupling portions 5L2 and 5L3 with the shaft support portion 42L2, and the modern 5L6 provided on a site of a side of the extension portion 5L1 opposite to the shaft support portion 42L2. The temple 5RA includes the extension portion 5R1 coupled at the coupling portions 5R2 and 5R3 with the shaft support portion 42R2, and the modern 5R6 provided on a site of a side of the extension portion 5R1 opposite to the shaft support portion 42R2. The extension portions 5L1 and 5R1 correspond to a first extension portion and a second extension portion respectively, and the moderns 5L6 and 5R6 correspond to a first modern and a second modern respectively.

Here, the +X direction is the first direction from the shaft support portion 42L2 toward the shaft support portion 42R2. In addition, the −Z direction is the second direction that intersects with the +X direction, and in which the extension portion 5L1 extends from the shaft support portion 42L2 in the stretched state in which the temple 5LA is stretched. Furthermore, the −Y direction is the third direction that intersects each of the +X direction and the −Z direction, and in which the tip portion of the modern 5L6 is positioned with respect to the extension portion 5L1 in the bent state in which, for example, the temple 5LA is bent at the shaft support portion 42L2 to be along the +X direction. Further, when the temple 5LA in the bent state is viewed from the −Z direction, as illustrated in FIG. 14, the extension portion 5L1 extends from the shaft support portion 42L2 to incline in the +Y direction that is a direction opposite to the third direction while proceeding toward the +X direction. In addition, when the temple 5RA in the bent state is viewed from the −Z direction, as illustrated in FIG. 14, the extending portion 5R1 extends from the shaft support portion 42R2 to incline in the +Y direction while proceeding toward the −X direction.

With this, compared to the head-mounted display apparatus of the first comparative example described above, the dimension in the +Y direction of the head-mounted display apparatus 1A, that is, a vertical dimension, can be reduced, when the head-mounted display apparatus 1A with the temples 5LA and 5RA being in the bent state is viewed from the −Z direction. Accordingly, the head-mounted display apparatus 1A can be more easily accommodated.

The pivot shaft RLA of the temple 5LA and the pivot shaft RRA of the temple 5RA are inclined in a direction approaching the center line CT parallel to the −Y direction and passing through the center of the head-mounted display apparatus 1A in the +X direction while proceeding toward the −Y direction when viewed from the −Z direction.

With this, when the temple 5LA is set in the bent state, the extension portion 5L1 of the temple 5LA can be made to extend to incline in the +Y direction from the shaft support portion 42L2 while proceeding toward the +X direction. Also, when the temple 5RA is set in the bent state, the extension portion 5R1 of the temple 5RA can be made to extend to incline in the +Y direction from the shaft support portion 42R2 while proceeding toward the −X direction. Thus, compared to the head-mounted display apparatus of the first comparative example described above, the dimension in the +Y direction of the head-mounted display apparatus 1A can be reduced, when the head-mounted display apparatus 1A with the temples 5LA and 5RA being in the bent state is viewed from the −Z direction. Accordingly, the head-mounted display apparatus 1A can be more easily accommodated.

The display unit 3 includes the left side display unit 3L and the right side display unit 3R. The left side display unit 3L includes the left side emitting unit 31L as an image emitting unit that emits image light for the left eye, and the left side light-guiding portion 32L as a light-guiding portion that guides image light for the left eye emitted from the left side emitting unit 31L to the predetermined visual recognition position. The right side display unit 3R includes the right side emitting unit 31R as an image emitting unit that emits image light for the right eye, and the right side light-guiding portion 32R as a light-guiding portion that guides image light for the right eye emitted from the right side emitting unit 31R to the predetermined visual recognition position. Note that, in the present embodiment, the visual recognition position to which the left side light-guiding portion 32L guides the image light for the left eye is a position corresponding to the left eye of the user, and the visual recognition position to which the right side light-guiding portion 32R guides the image light for the right eye is a position corresponding to the right eye of the user. Additionally, the temple 5LA is positioned on the center side of the head-mounted display apparatus 1A in the +X direction with respect to the left side emitting unit 31L, and the temple 5RA is positioned on the center side of the head-mounted display apparatus 1A in the −X direction with respect to the right side emitting unit 31R.

In this way, the temple 5LA can be disposed at a position near the head of the user with respect to the left side emitting unit 31L, and the temple 5RA can be disposed at a position near the head of the user with respect to the right side emitting unit 31R, allowing the temples 5LA and 5RA to suitably hold the head of the user. Accordingly, wearing feeling of the head-mounted display apparatus 1A can be improved.

### Second Embodiment

Next, a second embodiment of the present disclosure will be described.

A head-mounted display apparatus according to the present embodiment has a similar configuration and function to the head-mounted display apparatus 1A illustrated in the first embodiment. Here, in the head-mounted display apparatus 1A, the pivot shaft RLA of the temple 5LA is inclined in the +X direction and the pivot shaft RRA of the temple 5RA is inclined in the −X direction, while proceeding toward the −Y direction. Compared to this, in the head-mounted display apparatus according to the present embodiment, a pivot shaft of each temple is inclined in the +Z direction while proceeding toward the −Y direction. In this regard, the head-mounted display apparatus according to the present embodiment and the head-mounted display apparatus 1A are different. Note that, in descriptions below, portions that are identical or substantially identical to those described above are given identical reference signs, and descriptions thereof will be omitted.

Overall Configuration of Head-Mounted Display Apparatus

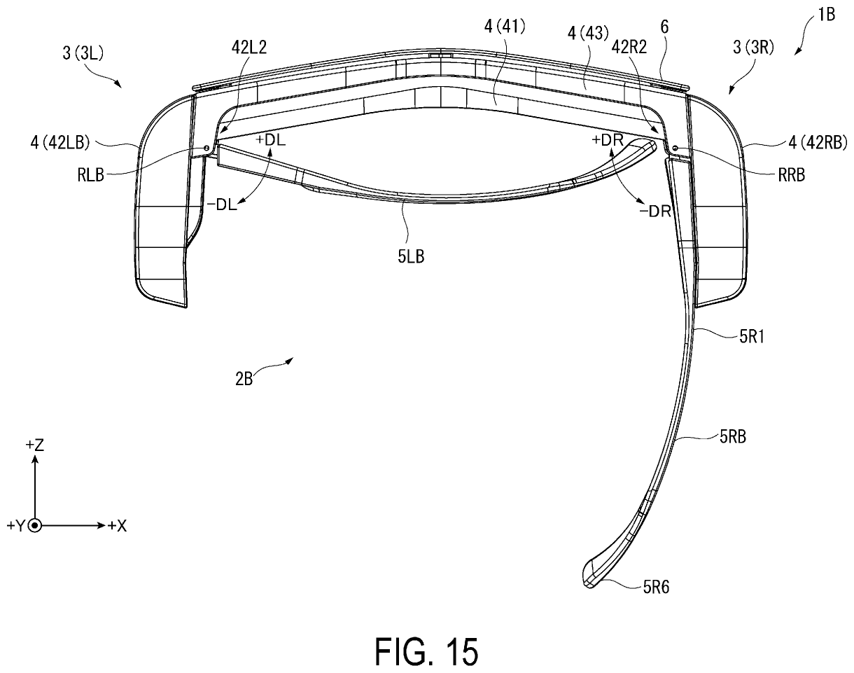

FIG. 15 is a plan view of a head-mounted display apparatus 1B according to the present embodiment, viewed from the +Y direction. Note that, in FIG. 15, illustration of the nose pad NP is omitted.

As illustrated in FIG. 15, the head-mounted display apparatus 1B according to the present embodiment has a similar configuration and function to those of the head-mounted display apparatus 1A, except that an apparatus body 2B is included instead of the apparatus body 2A. The apparatus body 2B has a similar configuration and function to those of the apparatus body 2A except that a left side housing 42LB and a right side housing 42RB are included instead of the left side housing 42LA and the right side housing 42RA, and temples 5LB and 5RB are included instead of the temples 5LA and 5RA.

The left side housing 42LB and right side housing 42RB, instead of the left side housing 42LA and the right side housing 42RA, configure the support portion 4. That is, the support portion 4 of the apparatus body 2B includes the frame 41, the left side housing 42LB, the right side housing 42RB, and the mounted member 43.

As with the left side housing 42LA and the right side housing 42RA, the left side housing 42LB and the right side housing 42RB are mounted at an end portion in the −X direction and at an end portion in the +X direction of frame 41 respectively. The left side housing 42LB accommodates the left side emitting unit 31L therein, and the right side housing 42RB accommodates the right side emitting unit 31R therein.

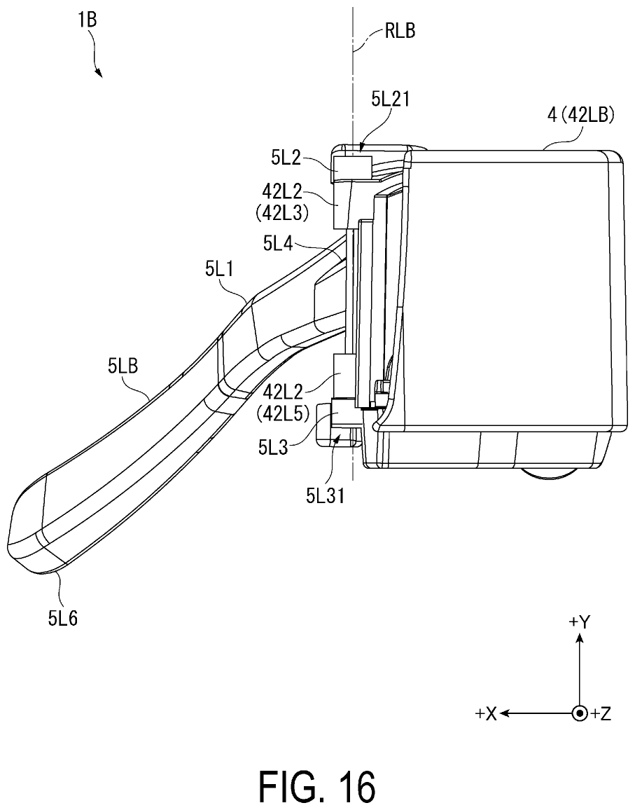

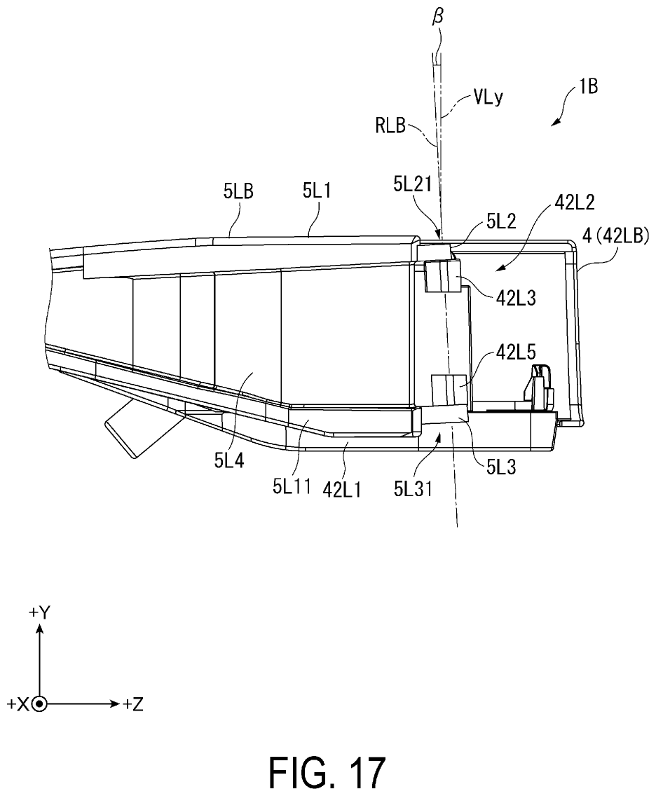

FIG. 16 is a front view of the left side housing 42LB and the temple 5LB in the stretched state viewed from the +Z direction. FIG. 17 is a side view of the left side housing 42LB and the temple 5LB in the stretched state viewed from the +X direction.

The left side housing 42LB has a similar configuration to that of the left side housing 42LA. That is, the left side housing 42LB includes the shaft support portion 42L2 positioned at an end portion in the +Z direction on the side surface 42L1 in the +X direction, as illustrated in FIG. 16 and FIG. 17.

The shaft support portion 42L2 includes the attachment member 42L3 positioned in the +Y direction and having the screw hole 42L4, and the attachment member 42L5 positioned in the −Y direction and having the screw hole 42L6.

The right side housing 42RB has a similar configuration to that of the right side housing 42RA. That is, the right side housing 42RB includes the shaft support portion 42R2 positioned at an end portion in the +Z direction on the side surface 42R1 in the −X direction, as illustrated in FIG. 15.

Pivot Shaft of Temple and Inclination of Pivot Shaft

The temple 5LB positioned in the −X direction has a similar configuration to that of the temple 5LA, and similar to the temple 5LA, is positioned on a center side of the head-mounted display apparatus 1B in the +X direction with respect to the left side emitting unit 31L. In other words, the temple 5LB includes the extension portion 5L1 including the coupling portions 5L2, 5L3, the disposition portion 5L4, and the recessed portion 5L5, and the modern 5L6.

Here, as illustrated in FIG. 16, the pivot shaft RLB of the temple 5LB supporting the coupling portions 5L2 and 5L3 at the shaft support portion 42L2 is parallel to the +Y direction when viewed from the +Z direction, and, similarly, is parallel to the +Y direction when viewed from the −Z direction.

On the other hand, as illustrated in FIG. 17, the pivot shaft RLB is inclined with respect to the +Y direction when viewed from the +X direction and, similarly, is inclined with respect to the +Y direction when viewed from the −X direction. In detail, the pivot shaft RLB is inclined in the −Z direction while proceeding toward the +Y direction, and is inclined in the +Z direction that is a direction opposite to the first direction while proceeding toward the −Y direction that is the third direction. In the present embodiment, when viewed from the +X direction or the −X direction, a crossing angle β between the pivot shaft RLB and the imaginary line VLy parallel to the +Y direction is approximately 3°.

The temple 5RB positioned in the +X direction also includes the extension portion 5R1 and the modern 5R6 similar to those of the temple 5RA, as illustrated in FIG. 15, and similar to the temple 5RA, is positioned on a center side of the head-mounted display apparatus 1B in the −X direction with respect to the right side emitting unit 31R. Furthermore, the pivot shaft RRB of the temple 5RB pivotally supported by the shaft support portion 42R2, although not illustrated, similar to the pivot shaft RLB, is parallel to the +Y direction when viewed from the +Z direction or the −Z direction, but is inclined with respect to the +Y direction when viewed from the +X direction or the −X direction. In detail, the pivot shaft RRB, similar to the pivot shaft RLB, is inclined in the −Z direction while proceeding toward the +Y direction, and is inclined in the +Z direction that is a direction opposite to the first direction while proceeding toward the −Y direction that is the third direction. Note that, the pivot shaft RRB is also inclined by approximately 3° with respect to the imaginary line VLy, when viewed from the +Z direction or the −Z direction.

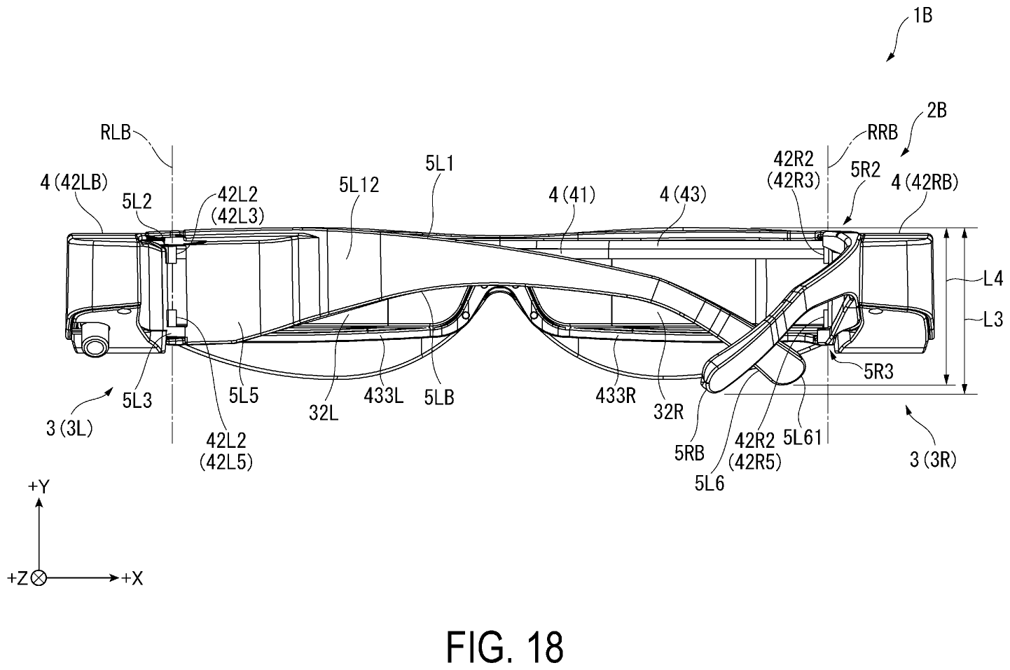

FIG. 18 is a rear view of the head-mounted display apparatus 1B viewed from the −Z direction. Note that, in FIG. 18, the temple 5LB is set in the bent state and the temple 5RB is set in the stretched state, in order to facilitate comparison between a case in which a disposition state of the temples 5LB and 5RB is the stretched state and the bent state respectively. Also, in FIG. 18, illustration of the nose pad NP is omitted.

A dimension in the +Y direction of the head-mounted display apparatus 1B when the temples 5LB and 5RB are in the stretched state is a dimension L3, as illustrated in FIG. 18.

The dimensions L3, in a case in which a head mounted display apparatus of a second comparative example that has a similar configuration to that of the head-mounted display apparatus 1B, but in which a pivot shaft of a temple is parallel to the +Y direction when viewed from the +/−X direction or the +/−Z direction, is viewed from the −Z direction, is identical to a dimension in the +Y direction of the head-mounted display apparatus of the second comparative example with the left and right temples being in the bent state.

Compared to this, when the temple 5LB is pivoted in the +DL direction and is set in the bent state, the extension portion 5L1 of the temple 5LB, similar to the temple 5LA, extends from the shaft support portion 42L2 to incline in the +Y direction that is the direction opposite to the −Y direction that is a direction in which the tip portion 5L61 of the modern 5L6 is positioned with respect to the extension portion 5L1, while proceeding toward the +X direction that is the first direction. Also, although not illustrated, when the temple 5RB is pivoted in the +DR direction and is set in the bent state, the extension portion 5R1 of the temple 5RB extends from the shaft support portion 42R2 to incline in the +Y direction that is a direction opposite to a direction in which the tip portion 5R61 of the modern 5R6 is positioned with respect to the extension portion 5R1, similar to the temple 5RA, while proceeding toward the −X direction that is a direction opposite to the first direction. For this reason, a dimension in the +Y direction of the head-mounted display apparatus 1B when the head-mounted display apparatus 1B is viewed from the −Z direction with the respective temples 5LB and 5RB being in the bent state, is a dimension L4 that is smaller than the dimension L3.

In this way, the dimension L4 in the +Y direction of the head-mounted display apparatus 1B with the temples 5 LB and 5RB being in the bent state is smaller than the above dimension L3, thus the head-mounted display apparatus 1B can be more easily accommodated.

### Effects of Second Embodiment

According to the head-mounted display apparatus 1B according to the present embodiment described above, similar effects to those of the head-mounted display apparatus 1A illustrated in the first embodiment can be achieved, and effects that follow can be achieved.

The pivot shaft RLB of the temple 5LB is inclined in the +Z direction that is a direction opposite to the second direction that is a stretching direction from the shaft support portion 42L2 of the temple 5LB in the stretched state, while proceeding toward the −Y direction that is the third direction. Similarly, the pivot shaft RRB of the temple 5RB is inclined in the +Z direction that is a direction opposite to a stretching direction from the shaft support portion 42R2 of the temple 5RB in the stretched state, while proceeding toward the −Y direction.

With this, similar to the case of the head-mounted display apparatus 1A, the extension portion 5L1 of the temple 5LB in the bent state can be made to extend from the shaft support portion 42L2 to incline in the +Y direction that is a direction opposite to the third direction, while proceeding toward the +X direction that is the first direction. Further, the extension portion 5R1 of the temple 5RB in the bent state can be made to extend from the shaft support portion 42R2 to incline in the +Y direction that is the direction opposite to the third direction, while proceeding toward the −X direction that is the direction opposite to the first direction. Thus, compared to the head-mounted display apparatus of the second comparative example described above, the dimension in the +Y direction of the head-mounted display apparatus 1B can be reduced, when the head-mounted display apparatus 1B with the temples 5LB and 5RB being in the bent state is viewed from the −Z direction. Accordingly, the head-mounted display apparatus 1B can be more easily accommodated.

### Modifications of Embodiments

Note that the present disclosure is not limited to the embodiments described above and that the present disclosure includes modifications, improvements, and the like within the scope in which the object of the present disclosure can be accomplished.

In each of the above embodiments, the temple 5LA is pivotally supported by the shaft support portion 42L2 provided on a front surface side of the side surface 42L1 on a side of the right side housing 42RA in the left side housing 42LA, and the temple 5LB is pivotally supported by the shaft support portion 42L2 provided on the front surface side of the side surface 42L1 on a side of the right side housing 42RB in the left side housing 42LB. Further, the temple 5RA is pivotally supported by the shaft support portion 42R2 provided on a front surface side of the side surface 42R1 on a side of the left side housing 42LA in the right side housing 42RA, and the temple 5RB is pivotally supported by the shaft support portion 42R2 provided on the front surface side of the side surface 42R1 on a side of the left side housing 42LB in the right side housing 42RB. In other words, the temple 5LA and temple 5RA are pivotally supported by the shaft support portion 42L2 provided at a position that is closer to a center in the +X direction of the head-mounted display apparatus 1A than the left side emitting unit 31L, and the temple 5LB and temple 5RB are pivotally supported by the shaft support portion 42R2 provided at a position that is closer to a center in the +X direction of the head-mounted display apparatus 1B than the right side emitting unit 31R. However, the present disclosure is not limited thereto, and the position of the shaft support 42L2 that supports the temples 5LA and 5RA in the shaft support portion 4, and the position of the shaft support 42R2 that supports the temples 5LB and 5RB in the shaft support portion 4 are not limited to the above.

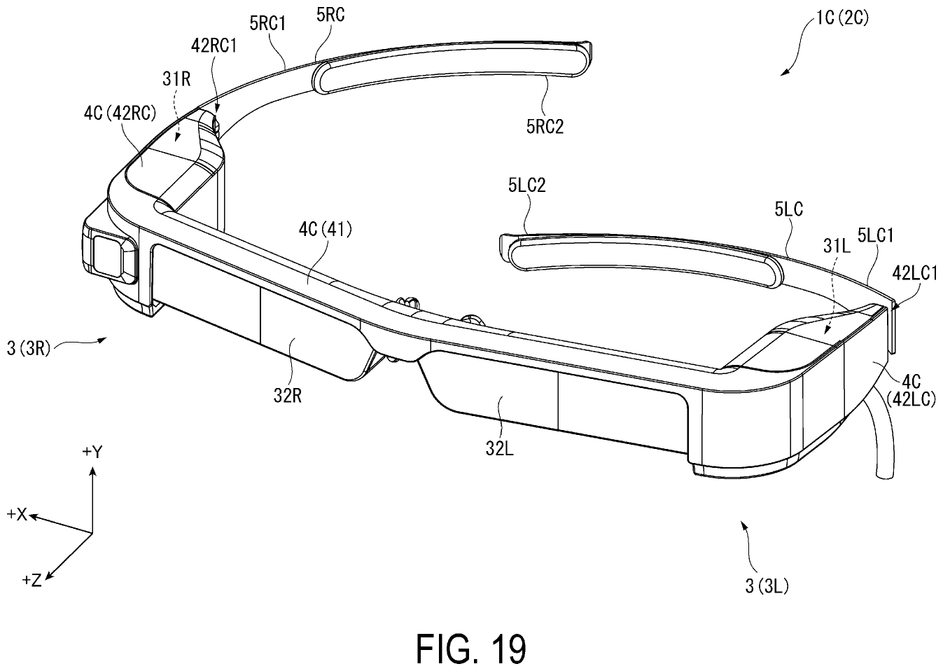

FIG. 19 is a perspective view of a head-mounted display apparatus 1C that is a modification of the head-mounted display apparatuses 1A and 1B, viewed from an upper front side.

For example, the present disclosure may be applied to the head-mounted display apparatus 1C illustrated in FIG. 19.

Similar to the head-mounted display apparatuses 1A and 1B, the head-mounted display apparatus 1C includes an apparatus body 2C and an unillustrated cover member. The apparatus body 2C includes the display unit 3 including the left side display unit 3L and the right side display unit 3R, a support portion 4C including the frame 41, a left side housing 42LC and a right side housing 42RC, and temples 5LC and 5RC.

The left side housing 42LC accommodates the left side emitting unit 31L that configures the left side display unit 3L therein. The left side housing 42LC includes a shaft support portion 42LC1 that pivotally supports the temple 5LC at an end portion in the −Z direction. Similarly, the right side housing 42RC accommodates the right side emitting unit 31R that configures the right side display unit 3R therein. The right side housing 42RC includes a shaft support portion 42RC1 that pivotally supports the temple 5RC at an end portion in the −Z direction.

The temple 5LC, similar to the temples 5LA and 5LB, includes an extension portion 5LC1 and a modern 5LC2 suspended on the left ear of the user, and the temple 5RC, similar to the temples 5RA and 5RB, includes an extension portion 5RC1 and a modern 5RC2 suspended on the right ear of the user.

In the head-mounted display apparatus 1C described above, a pivot shaft of the temple 5LC, similar to the pivot shafts RLA and RLB, may be inclined with respect to the +Y direction, and a pivot shaft of the temple 5RC, similar to the pivot shafts RRA and RRB, may be inclined with respect to the +Y direction.

Even with the head-mounted display apparatus 1C described above, similar effects to those of the head-mounted display apparatuses 1A and 1B can be achieved.

Note that, similar to the head-mounted display apparatus 1C, a temple in the −X direction need not be positioned on a center side of the head-mounted display apparatus in the +X direction with respect to the left side emitting unit 31L, and a temple in the +X direction also need not be positioned on a center side of the head-mounted display apparatus 1C with respect to the right side emitting unit 31R. Further, it is also possible that only one of the temples is positioned on a center side in the +X direction of the head-mounted display apparatus with respect to a corresponding image emitting unit.

In the first embodiment described above, the pivot shafts RLA and RRA of the respective temples 5LA and 5RA are inclined in a direction that is parallel to the +Y direction when viewed from the +/−X direction, and is approaching the center line CT while proceeding toward the −Y direction when viewed from the +/−Z direction. In the second embodiment described above, the pivot shafts RLB and RRB of the respective temples 5LB and 5RB are parallel to the +Y direction when viewed from the +/−Z direction, and are inclined in the Z direction while proceeding toward the −Y direction when viewed from the +/−X direction. However, the present disclosure is not limited thereto, and as long as an extension portion of a temple in the bent state extends from a support position of the temple in a support portion to incline in the +Y direction, orientation of a pivot shaft of the temple may be changed as appropriate.

That is, a position of a tip portion of a modern in the temple in the bent state is positioned in the +Y direction with respect to a position of the tip portion of the modern in the temple in the stretched sate, and when viewed from the −Z direction, when a dimension in the +Y direction of a head-mounted display apparatus when the temple is in the bent state is smaller than a dimension in the +Y direction of the head-mounted display apparatus when the temple is in the stretched state, orientation of the pivot shaft of each temple may be changed as appropriate.

Additionally, inclination of the pivot shafts RLA and RRA and inclination of the pivot shafts RLB and RRB may be combined. That is, the pivot shaft of the temple positioned in the −X direction may be configured to incline in the +X direction while proceeding toward the −Y direction when viewed from the +/−Z direction, and incline in the +Z direction while proceeding toward the −Y direction when viewed from the +/−X direction. Similarly, the pivot shaft of the temple positioned in the +X direction may be configured to incline in the −X direction while proceeding toward the −Y direction when viewed from the +/−Z direction, and incline in the +Z direction while proceeding toward the −Y direction when viewed from the +/−X direction.

Furthermore, the inclination of the pivot shaft illustrated in the first embodiment may be applied to one pivot shaft of the pivot shaft of the temple positioned in the −X direction and the pivot shaft of the temple positioned in the +X direction, and the inclination of the pivot shaft illustrated in the second embodiment may be applied to another pivot shaft.

In each of the above-described embodiments and modifications, the head-mounted display apparatuses 1A to 1C include the apparatus bodies 2A to 2C that can be used as head-mounted display apparatuses alone respectively, and the cover member 6 that can be mounted to the apparatus bodies 2A to 2C. However, the present disclosure is not limited thereto, and the cover member may be omitted.

In each of the above-described embodiments and modifications, the display unit 3 includes the left side emitting unit 31L as the image emitting unit for forming and emitting the image light for the left eye and the right side emitting unit 31R as the image emitting unit for forming and emitting the image light for the right eye, and the left side light-guiding portion 32L as the light-guiding portion that guides the image light for the left eye to the left eye of the user as the predetermined visual recognition position, and the right side light-guiding portion 32R as the light-guiding portion that guides the image light for the right eye to the right eye of the user as the predetermined visual recognition position. However, the present disclosure is not limited thereto, and the configuration of the display unit is not limited to that described above as far as an image can be displayed to be visually recognizable to the user. For example, the display unit may be configured to include an image display panel disposed in front of the eyes of the user, and may be configured to include an image projection unit that projects an image onto the retinas of the user. Also, a direction in which the light-guiding portion guides image light need not be the +X direction or the −X direction, and may be the +Y direction or the −Y direction.

In each of the above embodiments and modifications, the temple 5LA and temple 5RA are mirror symmetric, the temple 5LB and the temple 5RB are mirror symmetric, and the temple 5LC and the temple 5RC are mirror symmetric. However, the present disclosure is not limited thereto, and in a head-mounted display apparatus to which the present disclosure is applied, one temple and another temple need not be mirror symmetric. That is, of a pair of temples provided in a head-mounted display apparatus, respective shapes of one temple and another temple may be different from each other.

In each of the above-described embodiments and modifications, the display unit 3 is configured to include the left side display unit 3L that allows the image light for the left eye to enter in the left eye of the user for display, and the right side display unit 3R that allows the image light for the right eye to enter into the right eye of the user for display. However, the present disclosure is not limited thereto, and one of the left side display unit 3L and the right side display unit 3R may be omitted.

What is claimed is:

1. A head-mounted display apparatus, comprising:
a display unit configured to emit image light to display an image formed by the image light;
a support portion configured to support the display unit; and
a first temple and a second temple each pivotally provided on the support portion, wherein
the support portion includes
a first shaft support portion pivotally supporting the first temple about a first pivot shaft and
a second shaft support portion pivotally supporting the second temple about a second pivot shaft,
the first temple includes
a first extension portion coupled with the first shaft support portion and
a first modern provided on a side of the first extension portion opposite to the first shaft support portion,
the second temple includes
a second extension portion coupled with the second shaft support portion and
a second modern provided on a side of the second extension portion opposite to the second shaft support portion, and
provided that
a direction from the first shaft support portion toward the second shaft support portion is a first direction,
an extension direction, intersecting with the first direction, of the first extension portion from the first shaft support portion in a state in which the first temple is stretched is a second direction, and
a direction, intersecting with the first direction and the second direction, in which a tip portion of the first modern is positioned with respect to the first extension portion in a state in which the first temple is bent at the first shaft support portion to be along the first direction is a third direction, and
when a state in which the first temple is bent at the first shaft support portion and the second temple is bent at the second shaft support portion is viewed from the second direction,
the first extension portion extends from the first shaft support portion to incline in a direction opposite to the third direction while proceeding in the first direction and
the second extension portion extends from the second shaft support portion to incline in a direction opposite to the third direction while proceeding in a direction opposite to the first direction.

2. The head-mounted display apparatus according to claim 1, wherein
when viewed from the second direction, the first pivot shaft and the second pivot shaft are inclined, while proceeding in the third direction, in a direction approaching a center line parallel to the third direction and passing through a center of the head-mounted display apparatus in the first direction.

3. The head-mounted display apparatus according to claim 1, wherein
the first pivot shaft and the second pivot shaft are inclined in a direction opposite to the second direction while proceeding in the third direction.

4. A head-mounted display apparatus, comprising:
a display unit configured to emit image light to display an image formed by the image light;
a support portion configured to support the display unit; and
a first temple and a second temple each pivotally provided on the support portion, wherein
the support portion includes
a first shaft support portion pivotally supporting the first temple about a first pivot shaft and
a second shaft support portion pivotally supporting the second temple about a second pivot shaft,
the first temple includes
a first extension portion coupled with the first shaft support portion and
a first modern provided on a side of the first extension portion opposite to the first shaft support portion,
the second temple includes
a second extension portion coupled with the second shaft support portion and
a second modern provided on a side of the second extension portion opposite to the second shaft support portion, and
provided that
a direction from the first shaft support portion toward the second shaft support portion is a first direction,
an extension direction, intersecting with the first direction, of the first extension portion from the first shaft support portion in a state in which the first temple is stretched is a second direction, and
a direction, intersecting with the first direction and the second direction, in which a tip portion of the first modern is positioned with respect to the first extension portion in a state in which the first temple is bent at the first shaft support portion to be along the first direction is a third direction,
when viewed from the second direction, the first pivot shaft and the second pivot shaft are inclined, while proceeding in the third direction, in a direction approaching a center line parallel to the third direction and passing through a center of the head-mounted display apparatus in the first direction.

5. A head-mounted display apparatus, comprising:
a display unit configured to emit image light to display an image formed by the image light;
a support portion configured to support the display unit; and
a first temple and a second temple each pivotally provided on the support portion, wherein
the support portion includes
a first shaft support portion pivotally supporting the first temple about a first pivot shaft and
a second shaft support portion pivotally supporting the second temple about a second pivot shaft,
the first temple includes
a first extension portion coupled with the first shaft support portion and
a first modern provided on a side of the first extension portion opposite to the first shaft support portion,
the second temple includes
a second extension portion coupled with the second shaft support portion and
a second modern provided on a side of the second extension portion opposite to the second shaft support portion, and
provided that
a direction from the first shaft support portion toward the second shaft support portion is a first direction,
an extension direction, intersecting with the first direction, of the first extension portion from the first shaft support portion in a state in which the first temple is stretched is a second direction, and
a direction, intersecting with the first direction and the second direction, in which a tip portion of the first modern is positioned with respect to the first extension portion in a state in which the first temple is bent at the first shaft support portion to be along the first direction is a third direction,
the first pivot shaft and the second pivot shaft are inclined in a direction opposite to the second direction while proceeding in the third direction.

6. The head-mounted display apparatus according to claim 1, wherein
the display unit includes
an image emitting unit configured to emit the image light and
a light-guiding portion configured to guide the image light emitted from the image emitting unit to a predetermined visual recognition position and
at least one temple of the first temple and the second temple is positioned on a center side of the head-mounted display apparatus in the first direction with respect to the image emitting unit.
